(19) United States
(12) Patent Application Publication
(10) Pub. No.: US 2018/0163808 A1
(43) Pub. Date: Jun. 14, 2018

(54) FRICTION DEVICE AND FRICTION DAMPER COMPRISING A FRICTION DEVICE OF THIS TYPE

(71) Applicant: SUSPA GmbH, Altdorf (DE)

(72) Inventors: Michael Bauer, Freihung (DE); Michael Weder, Nurnberg (DE)

(21) Appl. No.: 15/840,475

(22) Filed: Dec. 13, 2017

(30) Foreign Application Priority Data
Dec. 14, 2016 (DE) 10 2016 225 036.1

(51) Int. Cl. F16F 7/08; F16F 7/09

(52) U.S. Cl. CPC F16F 7/082; F16F 2222/04; F16F 7/09

(57) ABSTRACT

A frictional device for a frictional damper comprises a friction lining carrier, at least one adjustable friction lining arranged on the friction lining carrier and an adjustment element for adjustably arranging the at least one friction lining on the friction lining carrier.

### CROSS-REFERENCES TO RELATED APPLICATIONS

This application claims the priority of German Patent Application, Serial No. 10 2016 225 036.1, filed Dec. 14, 2016, pursuant to 35 U.S.C. 119(a)-(d), the content of which is incorporated herein by reference in its entirety as if fully set forth herein.

### FIELD OF THE INVENTION

The invention relates to a frictional device for a frictional damper and to a frictional damper with a frictional device of this type.

### BACKGROUND OF THE INVENTION

Frictional dampers for producing frictional damping between two movably connected components are known, for example, from GB 1 284 536 A, DE 30 16 915 A1, EP 0 763 670 A2, U.S. Pat. No. 3,866,724 and U.S. Pat. No. 6,279,693 B1.

### SUMMARY OF THE INVENTION

The invention is based on the object of improving the functionality of a friction damper.

The object is achieved by a frictional device for a frictional damper, wherein the frictional device comprises a friction lining carrier, at least one friction lining adjustably arranged on the friction lining carrier and an adjustment element for adjustably arranging the at least one friction lining on the friction lining carrier. The essence of the invention consists in that a frictional action obtainable with a frictional damper is adjustable in a variable manner, in particular in a specifically variable manner In particular, a frictional force which is exertible by means of a frictional device in order to obtain the frictional action can be adjusted in a specific manner. The variable adjustability of the frictional action is in particular possible directly and without complication. The force-adjustable frictional damper with a frictional device of this type is useable flexibly and in particular permits the use in a product which is intended to have frictional actions which are adjustable in different ways, in particular based on requirements. A frictional damper of this type is advantageously useable, for example, in washing appliances. A single force-adjustable frictional damper according to the invention which, depending on the intended purpose in the washing appliance, can be adjusted to the required frictional force would suffice as a replacement part. In special-purpose engineering, a frictional damper can be used for damping vibrations, wherein the frictional action can be adapted and adjusted individually to the actual vibration conditions in the machine. The frictional damper according to the invention is also usable in exercise equipment. By changing the frictional action, the resultantly caused counterforce can be changed in a specific manner The frictional device comprises a friction lining carrier, at least one adjustable friction lining arranged on the friction lining carrier, and an adjustment element for adjustably arranging the at least one friction lining on the friction lining carrier. The resulting frictional action is changed by adjusting the at least one friction lining The friction lining carrier is in particular designed as a single part. The at least one friction lining is fixed on the friction lining carrier with respect to the longitudinal axis of the housing. In particular, the at least one friction lining is fixed on the friction lining carrier with respect to the longitudinal axis in the axial direction and/or in the circumferential direction about the longitudinal axis. It is also conceivable that the friction lining is secured on the friction lining carrier exclusively in the axial direction with respect to the longitudinal axis and in particular is not secured, in particular is shiftable, in the circumferential direction about the longitudinal axis.

A slotted adjustment guide by means of which the adjustment element is arranged adjustably, in particular relative to the friction lining carrier and in particular along an adjustment direction, permits an uncomplicated and direct adjustment of the adjustment element, in particular relative to the friction lining carrier. The adjustment takes place in particular along an adjustment direction. The adjustment of the adjustment element can take place manually and/or by motor, in particular by electric motor. The slotted adjustment guide is designed in particular in the form of a movement thread which in particular permits a continuous adjustment. It is alternatively conceivable to carry out an adjustment by means of a latching geometry having a plurality of direct latching steps. In this case, the slotted adjustment guide has a plurality of adjustment steps which are discontinuous, i.e. are separated from one another. The adjustment between two adjustment steps takes place discontinuously.

The adjustment element can interact directly with the friction lining by the friction lining being displaced by the adjustment element. The friction lining, which is composed in particular of a compressible material, is at least partially compressed and thereby pressed radially outward.

Additionally or alternatively, it is possible to provide a pressing carrier element which interacts directly with the adjustment element. The adjustment element brings about shifting of the pressing carrier element on which the friction lining is held. The pressing carrier element is in particular shifted exclusively radially with respect to a longitudinal axis. The pressing carrier element is part of what is referred to as an expanding piston, in which disc- or sleeve-shaped segment portions of a hollow cylinder are shifted radially with respect to the cylinder axis. The segment portions are produced from a rigid material, in particular with respect to the friction lining which is fitted on the outer side of the respective adjustment element. Rigid means that the individual segment portions do not deform. The segment portions are produced from a material which has a rigidity and/or strength which is greater than that of the material of the friction lining By means of the interaction with the adjustment element, the segment portions are shifted radially outward with respect to the longitudinal axis, as a result of which the outside diameter of the pressing carrier element, which is formed by the segment portions, is increased.

The pressing carrier element can be part of a longitudinally slit sleeve. In this case, the adjustment element brings about an expansion of the pressing carrier element in the circumferential direction about the longitudinal axis. The pressing carrier element is at least partially elastically deformed. The amount of the expansion is inhomogeneous along the circumferential direction. In the region of the slot, the expansion is comparatively great, in particular at maximum. The sleeve is in particular of thin-walled design. This means that the ratio of wall thickness to diameter of the sleeve is smaller than 0.1, in particular smaller than 0.05, in particular smaller than 0.01 and in particular smaller than 0.005. The longitudinally slit sleeve has structural flexibility which permits expansion of the sleeve in the circumferential direction.

The shifting of the friction lining takes place indirectly by shifting of the pressing carrier element. The friction lining is therefore not directly compressed, but rather displaced or shifted by the adjustment element. As a result of the shifting, the friction lining can be indirectly compressed by the friction lining being pressed against the inner side of the damper housing and/or by the friction lining being elongated in the circumferential direction on the expanding sleeve, for example as a consequence of the expansion in the circumferential direction, and therefore being compressed in the thickness direction.

A pressing portion according to the invention permits the direct application of a pressing force on the friction lining by the adjustment element. In particular, the pressing portion has a contour which is of variable design at least in sections along an adjustment direction. The contour can have, for example, a linear, progressive or degressive profile. It is also conceivable to combine these various profiles with one another in sections and in particular to provide an invariable contour in sections. For example, the contour can have an initial progressive profile which is adjoined by a linear profile and/or a degressive profile. A different combination is also conceivable. The pressing portion acts passively by the shifting of the adjustment element with respect to the friction lining carrier indirectly bringing about an adjustment of the friction lining relative to the friction lining carrier. The friction lining is at least partially shifted by the pressing force. Owing to the fact that the friction lining is produced in particular from a compressible material, in particular from a foamed plastic, the pressing force also at least partially brings about a compression of the friction lining.

Alternatively, it is possible that the pressing force is applied to the at least one adjustable friction lining indirectly. The at least one adjustable friction lining can be fastened to a pressing carrier element, wherein the pressing force is applied to the pressing carrier element by the pressing portion. An adjustment element of this type with pressing carrier elements is, for example, an expanding piston or a longitudinally, i.e. axially, slit sleeve.

It is essential that the adjustment element with the pressing portion is suitable to convert the, in particular axial, adjustment movement into an, in particular radially directed, pressing movement. The friction lining is thereby prestressed radially.

Alternatively, it is possible to design the pressing portion with at least one actively actuatable pressing element. An active pressing element can be designed, for example, as an element which is shiftable, in particular radially outwards, relative to the adjustment element in order to exert an active adjustment movement from the adjustment element via a corresponding kinematic device on the pressing element for pressing the friction lining. For the active adjustment movement, the kinematic device can have at least one force accumulator element, for example a spring element, and/or an actuator. The active adjustment movement can take place manually and/or by motor.

An embodiment of the pressing portion wherein the pressing portion interacts with the at least one adjustable friction lining in such a manner that a pressing force acting on the friction lining by adjustment of the adjustment element along the adjustment direction is oriented transversely, in particular radially, with respect to the adjustment direction, permits an advantageous application of the pressing force to the friction lining In particular, it is possible in an uncomplicated manner to convert a linear, in particular axial adjustment movement into a radial pressing movement acting in a fully circumferential manner.

An actuating portion which is designed noncircularly in a plane oriented perpendicularly to the adjustment direction simplifies a direct actuation of the adjustment element. The actuating portion can be designed as a slot-shaped depression which can be acted upon by means of a corresponding counter element.

An actuating element for actuating the adjustment element simplifies a direct actuation of the adjustment element. The actuating element has in particular a mating actuating portion which corresponds to the actuating portion on the adjustment element. In particular, the mating actuating portion is designed as a web-like elevation which can directly engage in the slot-like depression of the actuating portion. The actuating element is designed in particular in a manner integrated in the frictional damper and can be actuated directly, for example, via, for example, a radial opening in the housing of the frictional damper. It is also possible to mechanically couple the actuating element, for example to a fastening element of the frictional damper, and therefore the actuating element is adjustable via the fastening element.

A frictional device according to the invention, wherein the at least one adjustable friction lining is arranged annularly around the adjustment element, permits an advantageous, in particular uniform and homogeneous application of the pressing force by means of the adjustment element.

A rotationally secure fastening of the friction lining to the friction lining carrier wherein the at least one adjustable friction lining is held on the friction lining carrier in a manner secure against rotation ensures a reliable frictional action, in particular if the friction lining is acted upon by the adjustment element. An unintentional rotation of the friction lining as a consequence of a rotational movement of the adjustment element is prevented.

A, in particular window-like, radial recess of the friction lining carrier according to the invention permits an uncomplicated radial shifting of the friction lining The application of frictional force is simplified.

An additional, non-adjustably arranged friction lining according to the invention ensures a constant basic frictional force independently of the adjustably definable frictional force of the adjustable friction lining.

A frictional damper according to the invention with the frictional device has the advantages explained above, to which reference is hereby made.

A frictional damper comprising a first housing part with a first fastening element and a second housing part with a second fastening element, wherein the housing parts are shiftable relative to each other along a longitudinal axis is designed in an uncomplicated manner A housing of the frictional damper is of substantially two-part design.

An embodiment of the frictional damper wherein the first housing part is designed as an outer tube and the second housing part is designed as an inner tube which is insertable into the outer tube, permits a direct axial shifting of the housing parts with respect to each other.

A frictional damper according to the invention, wherein the at least one friction lining lies in a manner pressable adjustably against an inner side of the first housing part or against an inner side of the second housing part in order to produce a frictional force, permits an uncomplicated and direct application of the frictional force.

The arrangement of the frictional device in the frictional damper in such a manner that the adjustment direction is oriented concentrically with respect to the longitudinal axis permits an intuitive and direct adjustment of the frictional action.

Further advantageous refinements, additional features and details of the invention emerge from the description below of five exemplary embodiments with reference to the drawing.

### BRIEF DESCRIPTION OF THE DRAWING

FIG. 1 shows a perspective overall view of a frictional damper according to the invention with a frictional device according to the invention according to a first exemplary embodiment,

FIG. 2 shows a partial illustration corresponding to FIG. 1 of the frictional damper with the frictional device exposed,

FIG. 3 shows a longitudinal section according to the intersecting line III-III in FIG. 1 for illustrating the frictional device in a first adjustment position,

FIG. 4 shows an illustration corresponding to FIG. 3 in a second adjustment position different from the first adjustment position,

FIG. 5 shows an enlarged perspective illustration of a friction lining carrier of the frictional device in FIG. 2,

FIG. 6 shows a side view of the adjustment element according to FIG. 5,

FIG. 7 shows a longitudinal section according to the intersecting line VII-VII in FIG. 6,

FIG. 8 shows an enlarged perspective illustration of an adjustment element of the frictional device according to FIG. 2,

FIG. 9 shows a side view of the adjustment element according to FIG. 8,

FIG. 10 shows a view according to arrow X in FIG. 9.

FIG. 11 shows a perspective enlarged detailed view of a friction lining of the frictional device according to FIG. 2,

FIG. 12 shows a top view of the friction lining according to FIG. 11,

FIG. 13 shows an actuating element for actuating the adjustment element according to FIGS. 8 to 10,

FIG. 14 shows an illustration corresponding to FIG. 2 of a frictional device according to a second exemplary embodiment,

FIG. 15 shows an enlarged perspective illustration of the friction lining carrier of the frictional device according to FIG. 14,

FIG. 16 shows a side view of the friction lining carrier according to FIG. 15,

FIG. 17 shows a longitudinal section according to intersecting line XVII-XVII in FIG. 16,

FIG. 18 shows a perspective illustration of an individual friction lining of the frictional device in FIG. 14,

FIG. 19 shows an arrangement of the individual friction linings according to FIG. 18 of an arrangement according to the friction lining of the first exemplary embodiment in FIG. 11,

FIG. 20 shows a perspective illustration of an adjustment element according to a third exemplary embodiment,

FIG. 21 shows a sectional illustration according to intersecting line XXI-XXI in FIG. 20 with friction linings additionally illustrated,

FIG. 22 shows an illustration corresponding to FIG. 21 of the adjustment element with friction linings shifted radially outwards,

FIG. 23 shows a perspective illustration of an adjustment element according to a fourth exemplary embodiment,

FIG. 24 shows a longitudinal section according to intersecting line XXIV-XXIV in FIG. 23,

FIG. 25 shows an illustration corresponding to FIG. 24 of the adjustment element with friction linings shifted radially,

FIG. 26 shows a partial illustration corresponding to FIG. 2 of a frictional device according to a fifth exemplary embodiment,

FIG. 27 shows a longitudinal section of the frictional damper with the frictional device according to FIG. 26,

FIG. 28 shows a partial illustration corresponding to FIG. 2 of a frictional device according to a sixth exemplary embodiment,

FIG. 29 shows a longitudinal section according to intersecting line XXIX-XXIX in FIG. 28,

FIG. 30 shows a cross section according to intersecting line XXX-XXX in FIG. 28,

FIG. 31 shows a perspective illustration corresponding to FIG. 28, wherein, for the illustration of sliding elements, the friction lining is not shown,

FIG. 32 shows an illustration corresponding to FIG. 31 with displacement elements shifted radially outwards,

FIG. 33 shows a sectional illustration corresponding to FIG. 29 with displacement elements displaced radially,

FIG. 34 shows a sectional illustration corresponding to FIG. 30 with displacement elements shifted radially outwards,

FIG. 35 shows an enlarged perspective illustration of a displacement element according to FIG. 32,

FIG. 36 shows a partial illustration corresponding to FIG. 2 of a frictional device according to a seventh exemplary embodiment,

FIG. 37 shows a sectional illustration according to intersecting line XXXVII-XXXVII in FIG. 36,

FIG. 38 shows a sectional illustration according to intersecting line XXXVIII-XXXVIII in FIG. 36,

FIG. 39 shows an illustration corresponding to FIG. 37 with displacement elements shifted radially outwards,

FIG. 40 shows an enlarged detailed illustration of a displacement element according to FIG. 37.

### DESCRIPTION OF THE PREFERRED EMBODIMENT

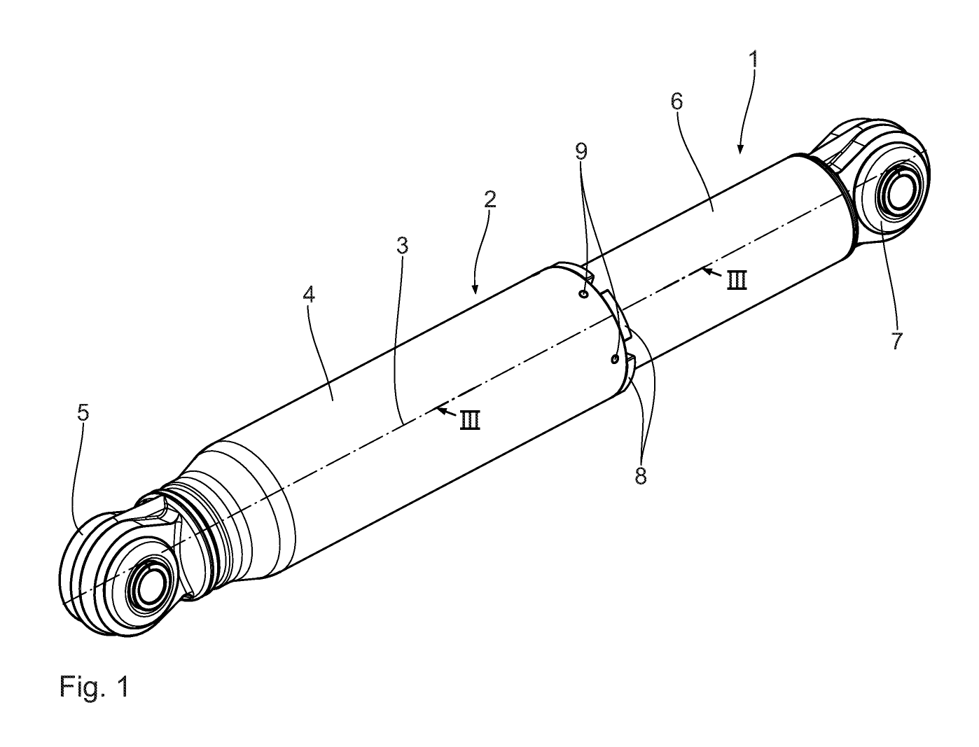

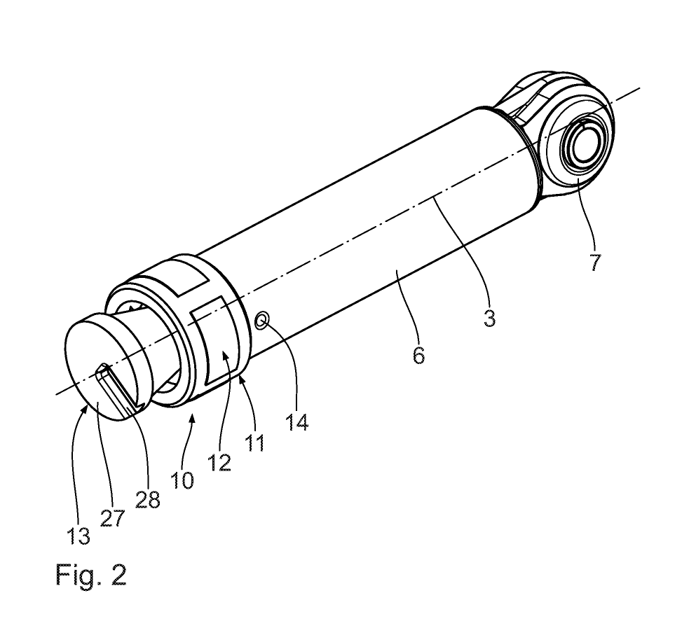

A frictional damper 1 illustrated in FIGS. 1 to 4 has a two-part housing 2 with a longitudinal axis 3.

The housing 2 has a first housing part 4 which is designed as an outer tube and to which a first fastening element 5 is attached. With the first fastening element 5, the frictional damper 1 can be fastened to a component. At the end facing the first fastening element 5, the first housing part 4 is closed. At the end opposite the first fastening element 5, the first housing part 4 is open. A second housing part 6 in the form of an inner tube is introduced into the first housing part 4 through said opening.

At the end opposite the first housing part 4, the second housing part 6 is closed. At the closed end of the second housing part 6, a second fastening element 7 is provided with which the frictional damper 1 can be fastened to a further component. The fastening elements 5, 7 are each designed, for example, as fastening eyes with inserted sleeves which are oriented transversely with respect to the longitudinal axis 3. The housing parts 4, 6 are shiftable relative to each other along the longitudinal axis 3. At the open end of the first housing part 4, a guide element 8 for the guided shifting of the second housing part 6 is provided.

According to the exemplary embodiment shown, the housing parts 4, 6 are each designed as cylinder tubes. It is basically also conceivable that the housing parts 4, 6 have a noncircular contour in a plane perpendicular to the longitudinal axis 3. For example, the housing parts 4, 6 can be designed as square tubes, rectangle tubes or oval tubes. In the case of a design of this type, rotation of the housing parts 4, 6 with respect to the longitudinal axis 3 is prevented by means of a form fit.

The frictional damper 1 furthermore has pull-out protection which prevents the second housing part 6 from being pulled unintentionally far out of the first housing part 4. According to the exemplary embodiment shown, the pull-out protection is ensured by the fact that radially inwardly protruding shaped elements 9 which are arranged along a circular line about the longitudinal axis 3 are provided on the first housing part 4. The shaped elements 9 engage behind the guide element 8 in the interior of the first housing part 4. The guide element 8 is secured on the first housing part 4 axially and radially with respect to the longitudinal axis 3. The guide element 8 projects inwards on the first housing part 4 in the radial direction with respect to the longitudinal axis 3.

According to the exemplary embodiment shown, a frictional device 10 is fastened to the second housing part 6, i.e. to the inner tube. The frictional device 10 comprises a friction lining carrier 11, an adjustable friction lining 12 arranged on the friction lining carrier 11, and an adjustment element 13 for adjustably arranging the friction lining 12 on the friction lining carrier 11. The frictional device 10 is secured on the second housing part 6 along the axial direction of the longitudinal axis 3 and with respect to rotation about the longitudinal axis 3. According to the exemplary embodiment shown, the fastening of the frictional device 10 to the second housing part 6 is formed by means of an impression 14 on the inner tube for the clamping of the friction lining carrier 11.

The frictional device 10 protrudes on the second housing part 6 in the radial direction with respect to the longitudinal axis 3. The guide element 8 forms a pull-out stop for the second housing part 6 by the frictional device 10, in particular the friction lining carrier 11, being prevented with a radially protruding annular shoulder 17 from axial shifting by means of the guide element 8.

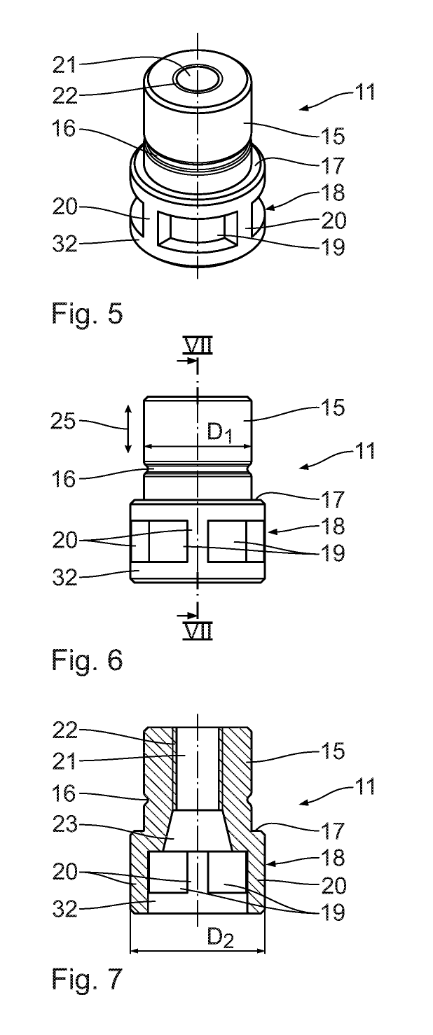

The construction of the friction lining carrier 11 is explained in more detail below with reference to FIGS. 5 to 7. The friction lining carrier 11 is designed as a single part, for example from plastic. The friction lining carrier 11 is of substantially hollow-cylindrical design with a pin-like anchoring portion 15 with which the friction lining carrier 11 is plugged on the end side into the inner tube of the second housing part 6. The anchoring portion 15 has an encircling inner groove 16 in which the impression 14 engages in order to hold the friction lining carrier 11 on the second housing part 6. In the region of the anchoring portion 15, the friction lining carrier 11 has a first outside diameter D₁ which substantially corresponds to the inside diameter of the inner tube of the second housing part 6.

The friction lining carrier 11 has the radially protruding annular shoulder 17 which adjoins the anchoring portion 15 and with which the friction lining carrier 11 lies against an annular end side of the second housing part 6. The friction lining carrier 11 is supported axially on the inner tube of the second housing part 6 by the annular shoulder 17.

The annular shoulder 17 is connected to a carrier portion 18 along an axial direction. The carrier portion 18 has a second outside diameter D₂ which is larger than the first outside diameter D₁. The second outside diameter D₂ substantially corresponds to the inside diameter of the outer tube of the first housing part 4. The carrier portion 18 has, along the outer circumference, a plurality of, in particular at least one and, according to the exemplary embodiment shown, precisely four, window-like radial recesses 19. Two adjacent radial recesses 19 are in each case separated from each other by an axial web 20. On the end side, the friction lining carrier 11 has an annular web 32 in the region of the carrier portion 18.

The friction lining carrier 11 has a passage bore 21 along an axial direction. The passage bore 21 is designed in the region of the anchoring portion 15 with a slotted adjustment guide 22 in the form of a movement thread. In the region of the transition from the anchoring portion 15 to the carrier portion 18, the passage bore 21 is designed as a frustoconical supporting portion 23.

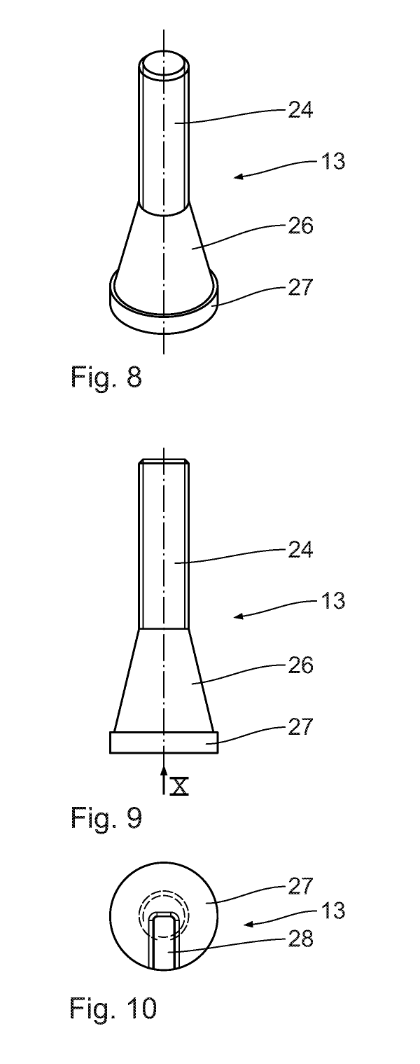

The adjustment element 13 is explained in more detail below with reference to FIGS. 8 to 10. The adjustment element 13 has an adjustment pin 24. The adjustment pin 24 has an external thread which corresponds to the internal thread of the slotted adjustment guide 22. The adjustment element 13 can be arranged so as to be adjustable with the adjustment pin 24 on the slotted adjustment guide 22 of the friction lining carrier 11 along an adjustment direction 25. The adjustment direction 25 corresponds to an axial direction of the friction lining carrier 11.

The frictional device 10 is arranged in the frictional damper 1 in such a manner that the adjustment direction 25 is oriented with respect to the longitudinal axis 3.

Provided adjacent to the adjustment pin 24 is a pressing portion 26 which, starting from the adjustment pin 24, has a conically expanding contour. At an outer end, the adjustment element 13 has a bearing element 27 with which the adjustment element 13 can lie on the end side against the friction lining carrier 11 in order to limit the adjustment.

An actuating portion 28 which is designed as an eccentrically arranged slot-like depression is provided on the end face of the bearing element 27.

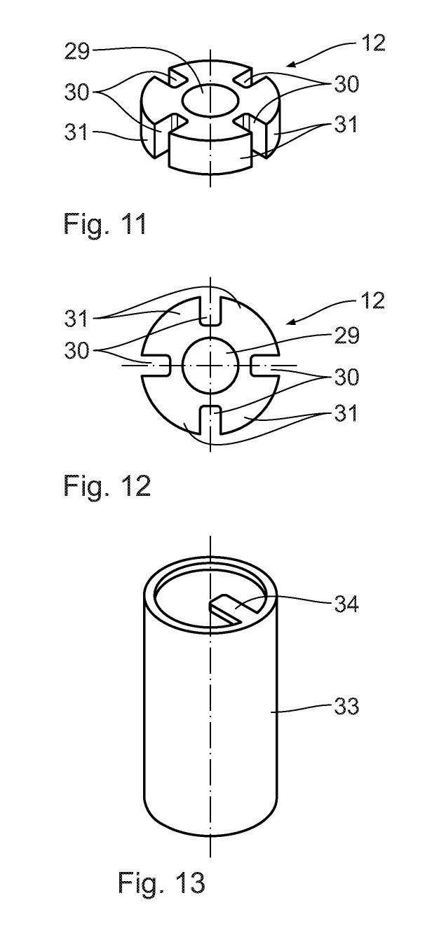

The friction lining is explained in more detail below with reference to FIGS. 11 and 12. The friction lining 12 is of substantially annular-disc-shaped design with a central circular opening 29 through which the adjustment element 13 can be guided. Along the outer circumference, the friction lining 12 is provided with a plurality of radially inwardly protruding recesses 30 with which the friction lining 12 can be fixed on the axial webs 20 of the friction lining carrier 11. This ensures protection against rotation for the friction lining 12 in the friction lining carrier 11. Between the recesses 30, the friction lining 12 in each case has radially protruding friction lining portions 31. The geometry of the friction lining portions 31 substantially corresponds to the size of the opening of the radial recesses 19 on the friction lining carrier 11.

The friction lining 12 can be arranged in the friction lining carrier 11, in particular within the carrier portion 18, in such a manner that the friction lining portions 31 protrude outwards in the radial direction through the radial recesses 19. On account of the axial webs 20 engaging in the recesses 30, the friction lining 12 is fixed radially in a rotational direction about the longitudinal axis 3. By means of the encircling annular web 32 which is on the end face and is engaged behind by the friction lining portions 31, the friction lining 12 is fixed on the friction lining carrier 11 along the axial direction.

An actuating element is explained in more detail below with reference to FIG. 13. The actuating element 33 is of substantially hollow-cylindrical design and on the end face has a mating actuating portion 34 which, according to the exemplary embodiment shown, is designed as a raised radial projection arranged eccentrically with respect to the longitudinal axis 3. The mating actuating portion 34 is designed in a manner corresponding to the actuating portion 28. It is essential that, by means of the interaction of the actuating portion 28 with the mating actuating portion 34, the adjustment element 13 is connectable to the actuating element 33 in a manner transmitting torque about the longitudinal axis 3. In particular, there is a form fit between the adjustment element 13 and the actuating element 33. This is possible in particular by the fact that the respective contour of actuating portion 28 and mating actuating portion 34 is of non-circular design in a plane perpendicular to the longitudinal axis 3. For example, a polygonal stub contour or polygonal socket contour, in particular a square or hexagonal contour, is also conceivable. According to the exemplary embodiment shown, the actuating element 33 can be designed in a manner integrated in the first housing part 4 and can be fastened, for example, to the first fastening element 5.

Instead of the form fit for transmitting torque from the actuating element 33 to the adjustment element 13, use can additionally or alternatively also be made of a force fit, in particular frictional fit.

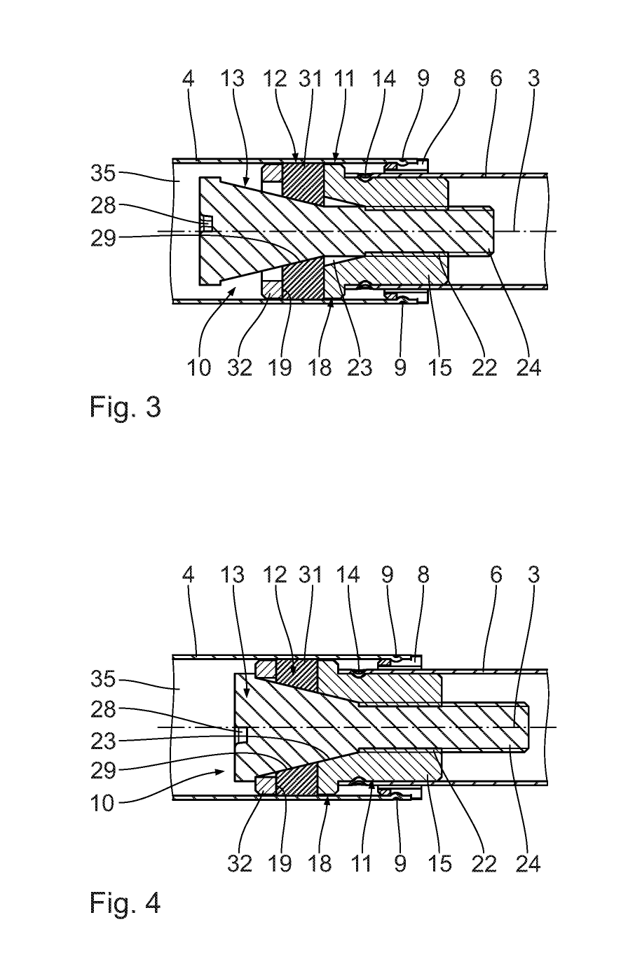

The function of the frictional damper is explained in more detail below with reference to FIG. 3. The frictional device 10 is held with the friction lining carrier 11 in the inner tube 6. The friction lining 12 is placed in the carrier portion 18 of the friction lining carrier 11 such that the friction lining portions 31 are arranged in the radial recesses 19. The adjustment element 13 is guided with the adjustment pin 24 through the opening 29 of the friction lining 12 and screwed by the external thread to the slotted adjustment guide 22 of the friction lining carrier 11.

According to the exemplary embodiment shown, the outside diameter of the adjustment pin 24 is smaller than the inside diameter of the opening 29. As long as the adjustment element 13 is screwed slightly into the friction lining carrier 11 in such a manner that only the adjustment pin 24 is arranged within the opening 29, a radial expansion of the friction lining 12 does not take place.

By means of actuation of the adjustment element 13 by means of the actuating element 33 by the mating actuating portion 34 lying against the actuating portion 28, a torque can be transmitted from the actuating element 33 to the adjustment element 13. As a result of the slotted adjustment guide 22, the rotational movement of the adjustment element 13 brings about axial shifting of the adjustment element 13. The axial shifting of the adjustment element 13 along the longitudinal axis 3 causes the conically expanding pressing portion 26 to be increasingly pushed into the opening 29 of the friction lining 12.

As soon as the outside diameter of the pressing portion 26 is larger than the inside diameter of the opening 29 of the friction lining 12, a radially outwardly acting pressing force is applied to the friction lining 12. The pressing force firstly brings about compression of the material from which the friction lining 12 is produced. In addition, the friction lining portions 31 are pressed outwards radially through the radial recesses 19 as a result of the pressing force. The friction lining 12 is pressed directly against an inner side 35 of the first housing part 4, i.e. of the outer tube. Depending on the compressive force with which the friction lining 12 lies against the inner side 35 of the first housing part 4, a force results when shifting the housing parts 4, 6 relative to each other along the longitudinal axis 3.

An arrangement of this type is shown in FIG. 4. The adjustment element 13 is screwed to a maximum depth into the friction lining carrier 11. The adjustment element 13 lies with the bearing element 27 on the end face against the annular web 32 of the friction lining carrier 11. Further axial shifting of the adjustment element 13 along the longitudinal axis 3 is prevented. In addition, further axial shifting in the arrangement is prevented by the adjustment element 13 lying with the pressing portion 26 against the supporting portion 23. The supporting of the adjustment element 13 on the friction lining carrier 11 is robust. A maximum screwing-in depth is robustly defined.

In the arrangement shown in FIG. 4, a maximum pressing force of the pressing portion 26 onto the friction lining 12 is output. In this arrangement, the frictional action of the frictional damper 1 is at maximum.

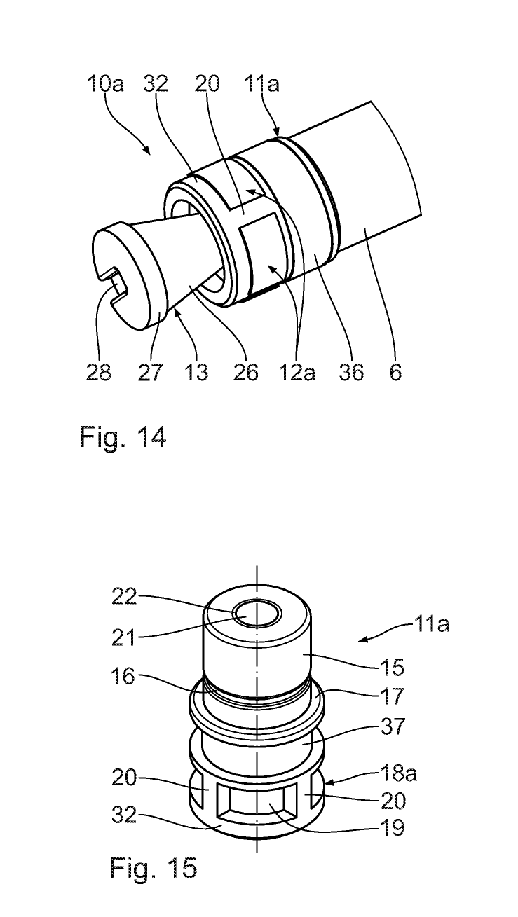

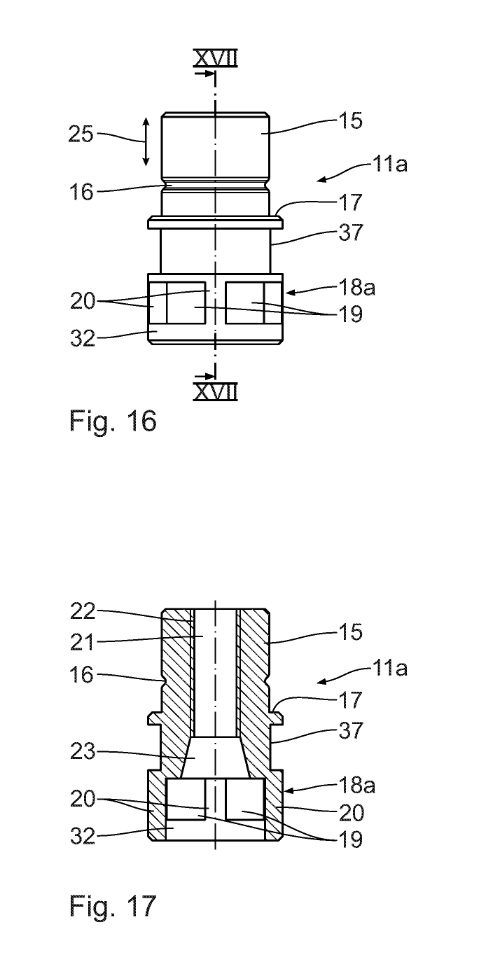

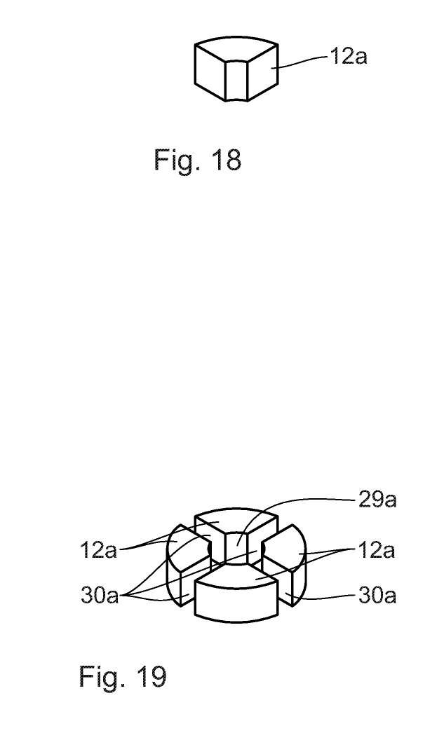

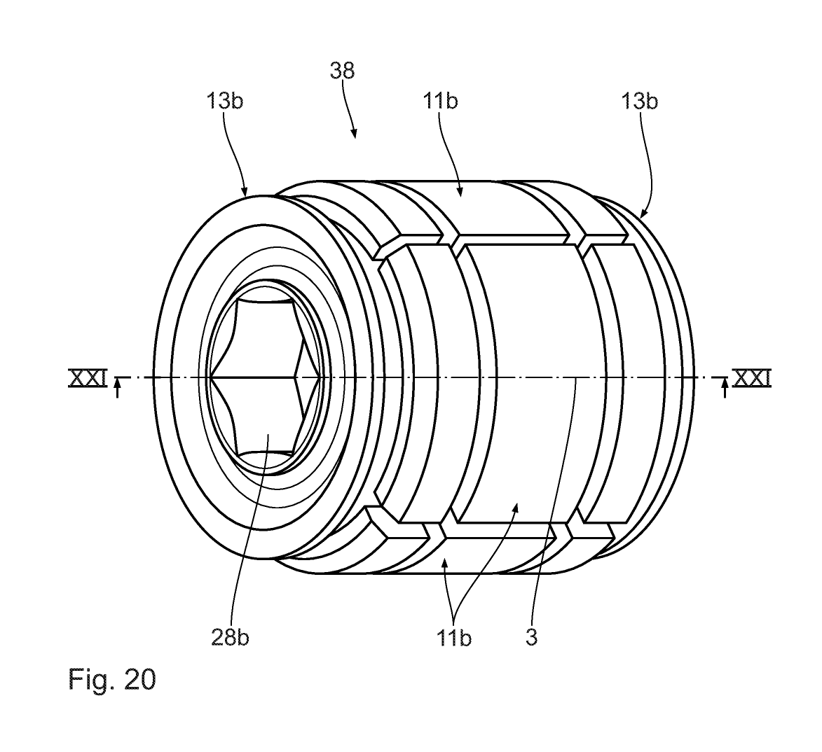

A second exemplary embodiment of the invention is described below with reference to FIGS. 14 to 19. Structurally identical parts are given the same reference signs as in the first exemplary embodiment, to the description of which reference is hereby made. Structurally different, but functionally identical parts are given the same reference signs followed by an a.

A substantial difference over the first embodiment consists in that a further non-adjustable friction lining 36 is arranged on the friction lining carrier 11a. For this purpose, the friction lining carrier 11a has an encircling inner groove 37. The non-adjustable friction lining 36 causes an invariable basic friction. The non-adjustable friction lining 36 protrudes radially on the friction lining carrier 11a in the region of the carrier portion 18a. The inner groove 37 is part of the carrier portion 18a.

A further difference of the frictional device 10a according to the second exemplary embodiment consists in a plurality of individual friction linings 12a being provided. According to the exemplary embodiment shown, four individual friction linings 12a which are separated from one another are provided, for example. The friction linings 12a can be positioned in an arrangement with respect to each other that the arrangement substantially corresponds to the shape of the friction lining 12 according to the first exemplary embodiment.

The friction linings 12a substantially correspond to a circular disc segment with an opening angle of, for example, 90°. The individual friction linings 12a can be arranged with respect to a disc contour in such a manner that they represent a substantially disc-shaped overall shape with opening 29a and recesses 30. The individual friction linings 12a can be arranged protruding radially through the window-like radial recesses 19 by means of the adjustment element 13 and can be designed in a radially protruding manner.

The adjustment of the frictional damping, i.e. of the radially oriented frictional force acting on the inner side 35, can be defined directly and in a continuously adjustable manner by means of the screwing-in depth of the adjustment element 13 on the friction lining carrier 11.

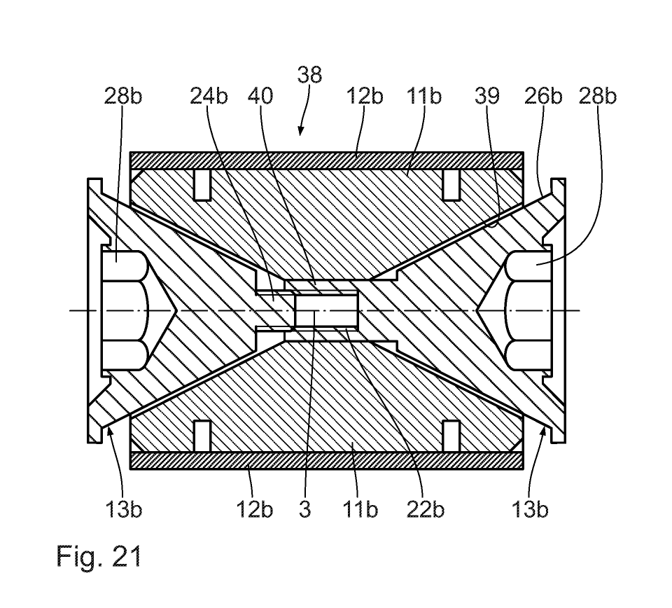

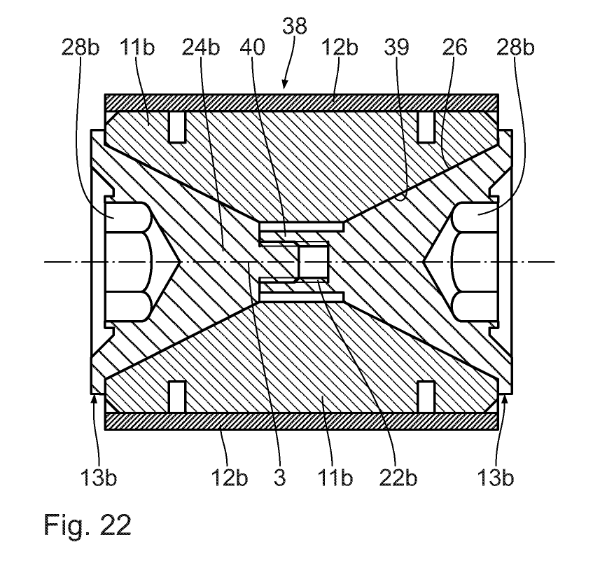

A third exemplary embodiment of the invention is described below with reference to FIGS. 20 to 22. Structurally identical parts are given the same reference signs as in the two first exemplary embodiments, to the description of which reference is hereby made. Structurally different, but functionally identical parts are given the same reference signs followed by a b.

The substantial difference over the previous embodiments consists in that an assembly 38 known in the form of an expanding piston has at least one adjustment element 13b by means of which the friction lining 12b is shiftable radially with respect to the longitudinal axis 3. Unlike in the previous exemplary embodiments, the friction lining 12b is not acted upon directly by the at least one adjustment element 13b. The adjustment element 13b has a pressing carrier element 39 which is shiftable radially. By means of the radial shifting of the pressing carrier element 39, the friction lining 12b is pressed against the inner side of the housing 2 of the frictional damper 1. The frictional force changes depending on the pressing force of the friction lining 12b.

According to the exemplary embodiment shown, two oppositely arranged adjustment elements 13b are provided along the longitudinal axis 3 and can be shifted towards each other or away from each other along the longitudinal axis 3 by means of a movement thread. The adjustment elements 13b each have on the end face an actuating element 28b in the form of a hexagon socket contour.

The adjustment elements 13b each have a conically designed pressing portion 26b which interacts in each case with friction lining carriers 11b interacting therewith. The friction lining carriers are segmented in a circumferential direction about the longitudinal axis 3. Four friction lining carriers 11b are arranged about the longitudinal axis 3 along the outer circumference. The friction lining carriers 11b are shiftable relative to one another. In particular, the friction lining carriers 11b are not connected directly to one another. On the outer lateral surface of the cylinder, a friction lining 12b is held, in particular fastened, for example adhesively bonded, on the respective friction lining carrier 11b. Each individual friction lining 12b is shifted radially outwards with the radial shifting of the respective friction lining carrier 11b. By means of this radial shifting by itself, the friction lining 12b is not mechanically stressed. Compression of the friction lining 12b arises by pressing against the inner side of the damper housing. In the circumferential direction, longitudinal recesses oriented parallel to the longitudinal axis 3 are provided between the friction linings 12b.

Alternatively, it is conceivable to provide a single-part friction lining 12b on the outer side of the expanding piston. By means of the radial shifting of the friction lining carrier 11b, the single-part friction lining 12b is expanded in the radial direction and is thereby shifted radially outwards and elongated. In addition, the friction lining 12b is pressed against the inner side of the damper housing. In the case of this embodiment (not shown in the figures), a standard, homogeneous and continuous action of frictional force in the circumferential direction is made possible.

On an inner side opposite the friction linings 12b, the friction lining carriers 11b have a pressing carrier element 39 which interacts in each case with the pressing portion 26b. By means of the axial shifting of the oppositely arranged adjustment elements 13b, the friction lining carriers 11b are shifted radially outwards with respect to the longitudinal axis 3.

The adjustment elements 13b each have, on the end face at an inner end, the adjustment pin 24b with a thread which engage in a slotted adjustment guide 22b with a corresponding mating thread for the adjustment movement along the longitudinal axis 3. The slotted adjustment guide 22b can be integrated in the oppositely arranged adjustment element 13b. If only one adjustment element 13b is provided, the mating thread can be integrated in the inner housing part of the housing 2.

A substantial advantage of the expanding piston 38 consists in that, by means of the radial shifting of the pressing carrier element 39 outwards, a frictional force which is uniform and is in particular homogeneous along the circumference can be applied to the inner side of the housing 2 of the frictional damper 1. The application of the frictional force is in particular independent of the positional relationship of the frictional device 10 in the frictional damper 1.

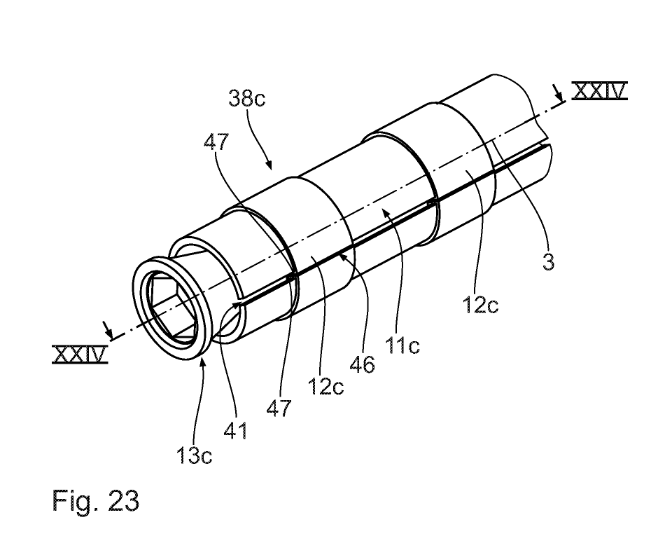

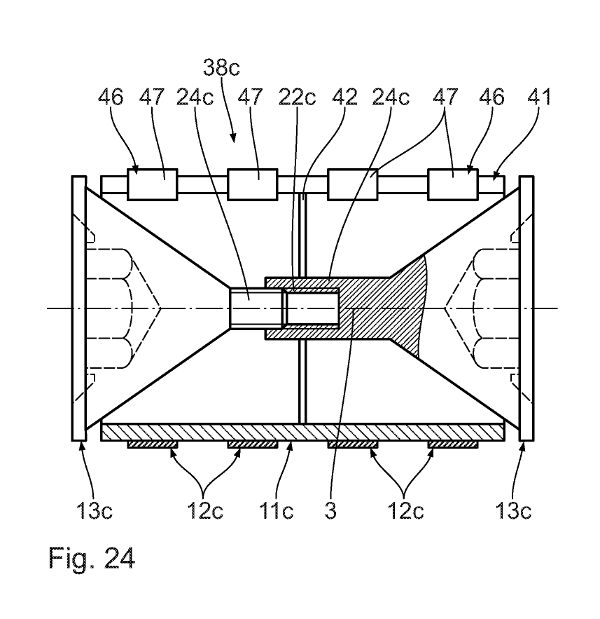

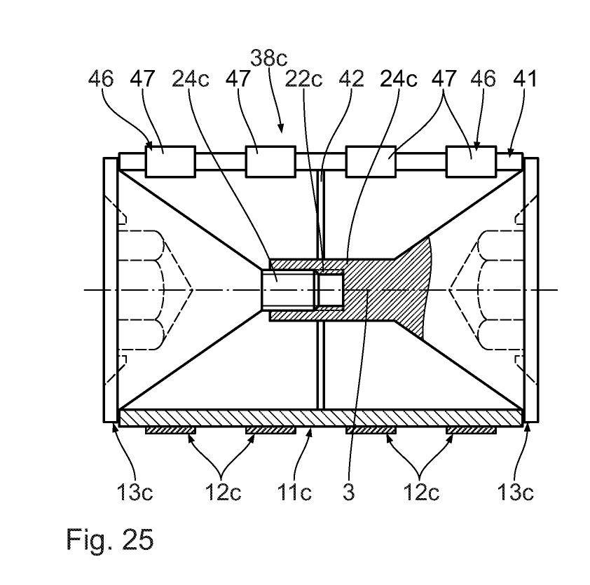

A fourth exemplary embodiment of the invention is described below with reference to FIGS. 23 to 25. Structurally identical parts are given the same reference signs as in the three first exemplary embodiments, to the description of which reference is hereby made. Structurally different, but functionally identical parts are given the same reference signs followed by a c.

The substantial difference over the previous exemplary embodiments consists in that the assembly 38c is designed as a longitudinally slit sleeve. The longitudinally slit sleeve 38c has a sleeve body which forms the friction lining carrier 11c. The friction lining carrier 11c has a longitudinal slot 41 running in particular parallel to the longitudinal axis 3. As a result, the assembly 38c has structural flexibility in the circumferential direction about the longitudinal axis 3. Adjustment elements 13c which can be screwed as friction lining carriers 11c into the sleeve body on the end face bring about radial expansion of the sleeve body and therefore a radially adjustable pressing force against the friction linings 12c attached to the outer side of the sleeve body. According to the exemplary embodiment shown, four separate friction linings 12c which are separated from one another are provided along the longitudinal axis 3. Each individual friction lining 12c is arranged as an extendible encircling friction ring on the outer side of the sleeve body. The friction linings 12c are designed in such a manner that, in a starting state, they each have an inside diameter which is slightly smaller than the outside diameter of the sleeve body in the starting state. This means that the friction linings 12c are arranged prestressed against the outer face of the sleeve body. An additional fastening of the friction linings 12c to the sleeve body is unnecessary. The production of the sleeve body is uncomplicated and cost-effective. Expansion of the sleeve body is not uniform substantially along the circumferential direction. This means that a comparatively increased extension and spreading occurs in the region of the longitudinal slot 41. In this region, a higher pressing force of the friction lining 12c against the inner side of the housing 2 of the frictional damper 1 should be expected.

It is advantageous if the slotted adjustment guide 22c is formed on the sleeve body on an inner side in a manner integrated in the form of an internal thread into which the adjustment elements 13c can be screwed, wherein, depending on the screwing-in depth of the adjustment elements 13c, i.e. the axial shifting thereof along the longitudinal axis 3, a corresponding axial expansion of the longitudinally slit sleeve takes place by means of the pressing portion 26.

According to the exemplary embodiment shown, the friction linings 12c are arranged in a strip-like manner on the sleeve body along a circumferential line about the longitudinal axis 3, in particular are fastened there. For this purpose, the strip-like friction linings 12c have a slot 46 which is in each case arranged in alignment with the longitudinal slot 41 of the sleeve body. In the region of the slot 46, the friction linings 12c each have clamp portions 47 which face away from one another, are arranged on the sleeve body in a manner protruding inwards and engage around the end faces of the longitudinal slot 41 of the sleeve body. The friction lining 12c is held mechanically on the sleeve body by said clamp portions 47. An expansion of the sleeve body with the adjustment elements 13c is unproblematic for the fastening of the friction lining 12c. In particular, repeated action upon the sleeve body by the at least one adjustment element 13c is unproblematic for the fastening of the friction lining 12c. The mechanical fastening, in particular by means of a form fit, prevents the friction lining 12c from being detached from the sleeve body if an adhesive fastening fails. Additionally or alternatively, it is possible for the friction linings 12c to be adhesively bonded on the sleeve body.

It is advantageous if the slotted adjustment guide 22c is held between an inner wall of the sleeve body and an outer wall of the sleeve with the slotted adjustment guide by means of flexible elements 42. The flexible elements 42 can be, for example, elastic bands and/or an elastic annular disc in order firstly to permit the axial fixing along the longitudinal axis and also to compensate for the radial expansion, i.e. the variable distance in the radial direction between the inner side of the sleeve and the outer side of the body, for the slotted adjustment guide.

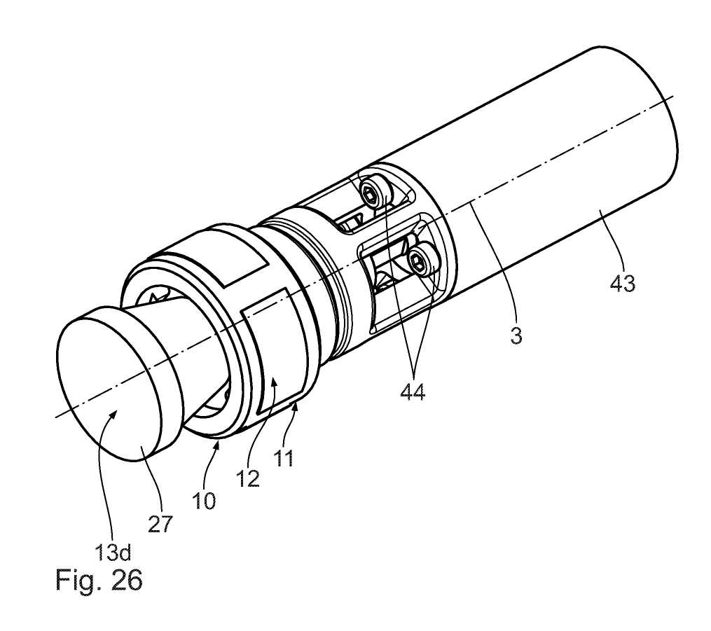

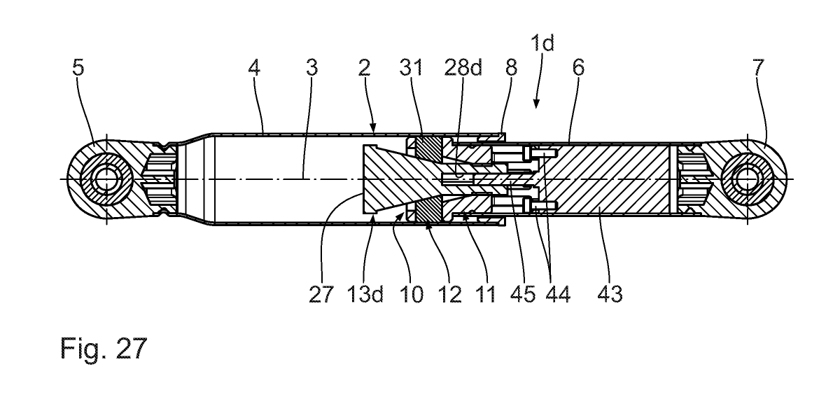

A fifth exemplary embodiment of the invention is described below with reference to FIGS. 26 and 27. Structurally identical parts are given the same reference signs as in the previous exemplary embodiments, to the description of which reference is hereby made. Structurally different, but functionally identical parts are given the same reference signs followed by a d.

The substantial difference over the previous exemplary embodiments consists in that the adjustment of the adjustment element 13d takes place by motor. For this purpose, a drive 43 is provided in the form of an electrical motor which is integrated in the second housing part 6. The drive 43 is held by means of fastening screws 44. The drive which can be designed with a transmission has an output shaft 45. The output shaft 45 serves for transmitting torque to the adjustment element 13d. At the same time, the output shaft 45 permits linear shifting of the adjustment element 13d along the longitudinal axis 3. This is possible, for example, by the fact that the output shaft 45 has a non-circular outer contour with respect to the longitudinal axis 3, and the adjustment element 13d has an inner contour corresponding to said outer contour. The non-circular inner contour of the adjustment element 13d is a fastening element 28d. A contour of this type can be, for example, of square or hexagonal design.

The end side 27 of the adjustment element 13d is of flat design.

It is clear that the other exemplary embodiments in which the friction lining is in each case shifted radially can also be driven by motor.

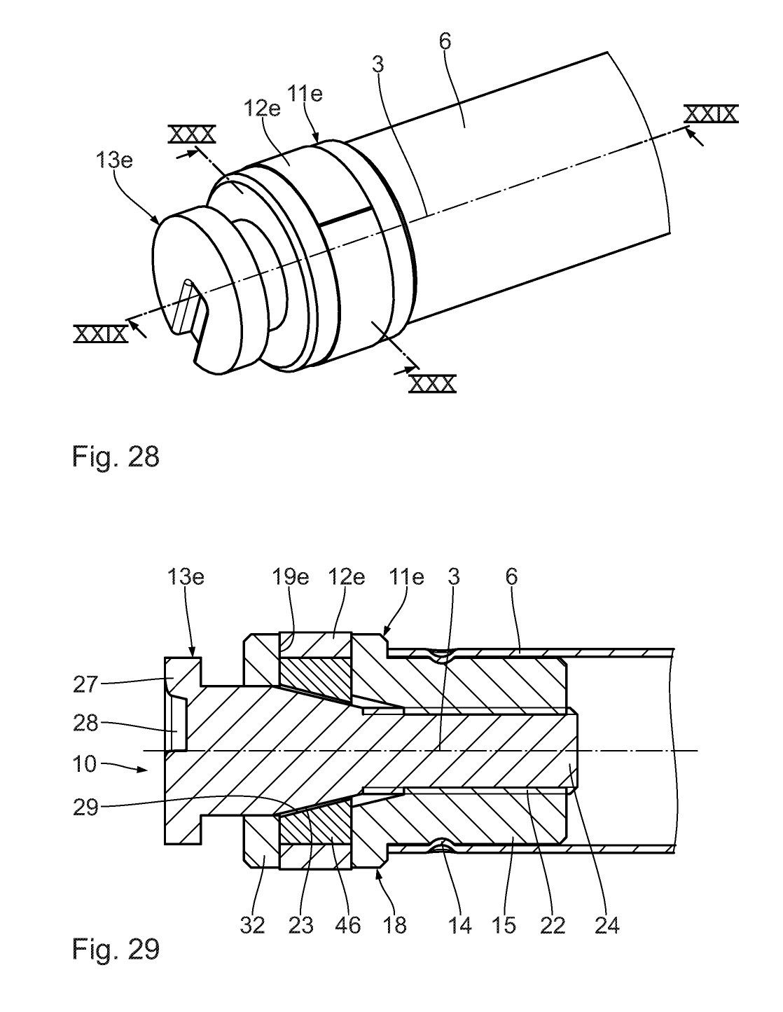

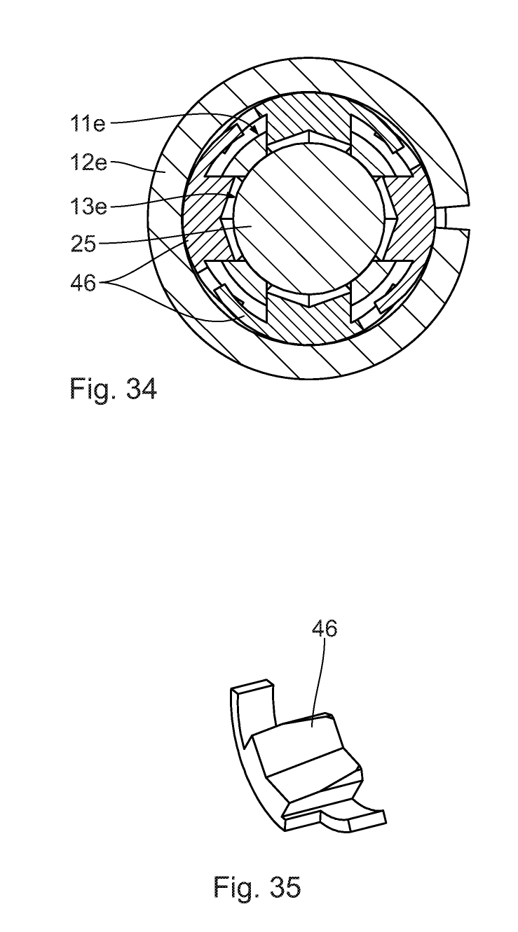

A sixth exemplary embodiment of the invention is described below with reference to FIGS. 28 to 35. Structurally identical parts are given the same reference signs as in the previous exemplary embodiments, to the description of which reference is hereby made. Structurally different, but functionally identical parts are given the same reference signs followed by an e.

The substantial difference over the previous exemplary embodiments consist in that the adjustment element 13e interacts directly with at least one displacement element, four displacement elements 46 according to the exemplary embodiment shown. The displacement elements 46 are designed in the shape of ring segments. In the circumferential direction about the longitudinal axis 3, the displacement elements 46 have a substantially S-shaped contour with a central portion and extension portions which are moulded integrally thereon, extend in the circumferential direction about the longitudinal axis 3 and are arranged along the circumferential direction about the longitudinal axis 3 in such a manner that the extension portions of adjacent displacement elements intermesh and permit a radial expansion of the displacement elements 46 with respect to the longitudinal axis 3. The two extension portions which are moulded integrally onto a central portion are arranged offset with respect to the longitudinal axis 3 of the housing.

The four displacement elements 46 are in each case of identical design. On their inner side which faces the adjustment element 13e, the displacement elements 46 are designed in a manner corresponding to the outer contour of the displacement element 13e.

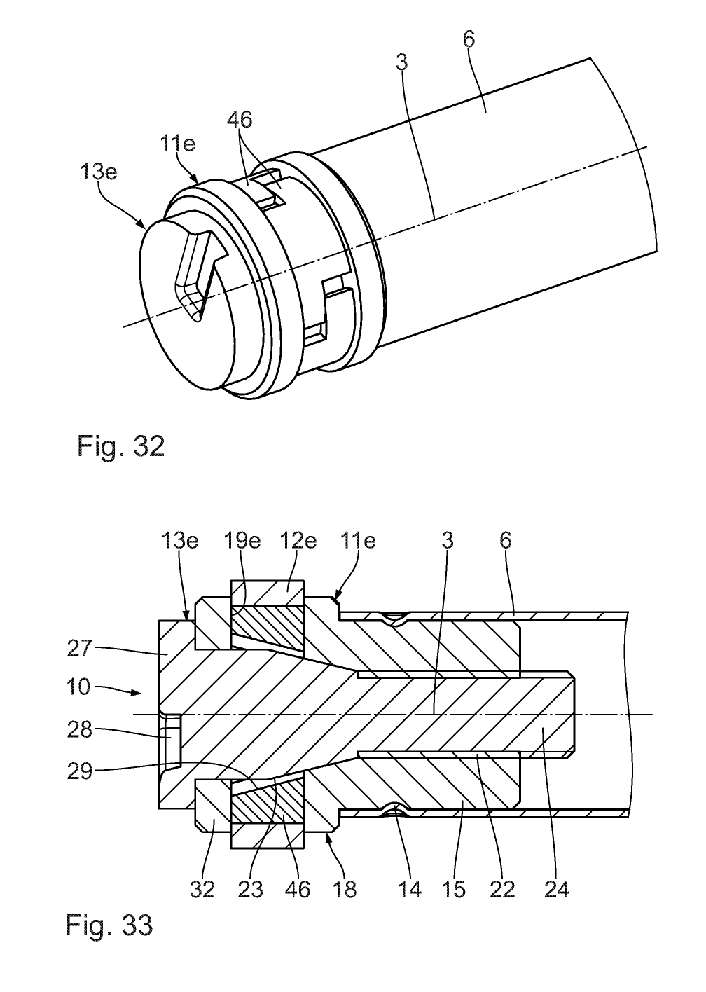

A shifting of the adjustment element 13e from the illustration according to FIG. 29 into the illustration according to FIG. 33 brings about radial shifting of the displacement elements 46 outwards. While, in the starting position according to FIG. 31, the extension portions of the displacement elements 46 lie against one another both in the circumferential direction and in the longitudinal direction with respect to the longitudinal axis 3, the extension portions of the displacement elements 46 are spaced apart from one another in the radially expanded arrangement according to FIG. 32. As a result of the fact that a plurality of displacement elements 46 formed separately from one another are provided, the radial expansion, i.e. the movability thereof relative to one another, is ensured.

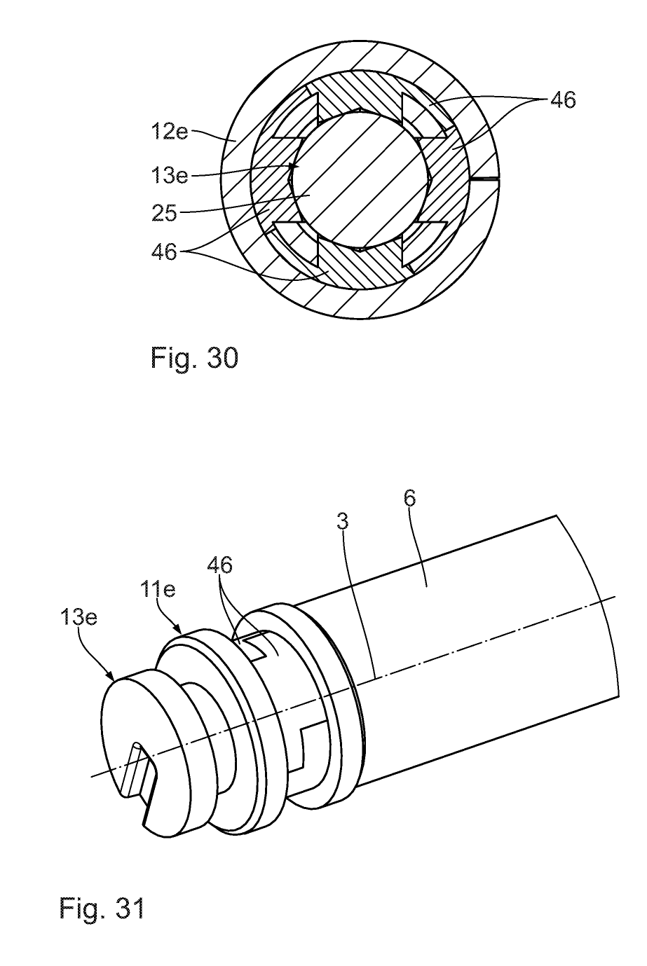

The friction lining 12e is integrally designed as a friction strip which is placed annularly about the displacement elements 46. The two end-face ends of the friction strip, which ends, according to the illustrations in FIG. 30, substantially lie against each other and in particular face each other, are shiftable relative to each other. As a result, the friction strip which is shaped to form the ring can be expanded. The friction strip has a movability, in particular in the circumferential direction about the longitudinal axis 3. The friction lining 12e is in each case arranged so as to be shiftable in the circumferential direction with respect to the displacement elements 46. The friction lining 12e is in particular produced from foam. The friction lining 12e lies with its outer lateral surface of the cylinder against the inner side of the outer tube. Shifting of the adjustment element 13e causes the displacement elements 46 to be pushed radially outwards and the foam material of the friction lining 12e to thereby be compressed radially. Since radial shifting outwards is not possible, the friction strip is compressed, and therefore the frictional force is increased.

The friction lining 12e can also be designed as a closed friction ring by, for example, the two end-face ends of the friction strip being connected to each other, for example being welded to each other. The friction lining is then designed as a closed friction ring.

The friction lining 12e can also be of multi-part design and can in particular be fastened to in each case one of the displacement elements 46.

The substantial advantage of the embodiment according to the sixth exemplary embodiment consists in that the overall height of the friction lining is reduced by the use of the adjustment elements 46. For the adjustment of the force from an adjustable force minimum to an adjustable force maximum, a reduced adjustment distance of the adjustment element 13e is therefore sufficient. As a result, fewer revolutions of the adjustment element 13e are required. It has been found that the frictional effect with the friction lining 12e which has a smaller friction lining extension in the radial direction with respect to the longitudinal axis 3 is greater than in the case of a friction lining 12e with a large radial thickness.

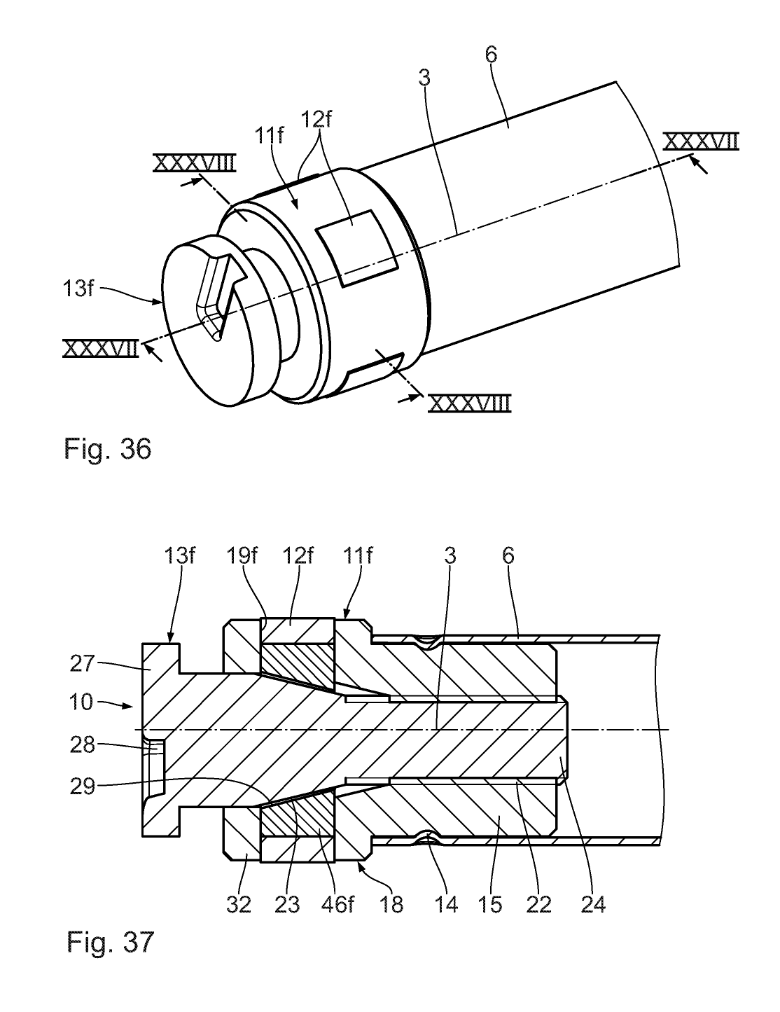

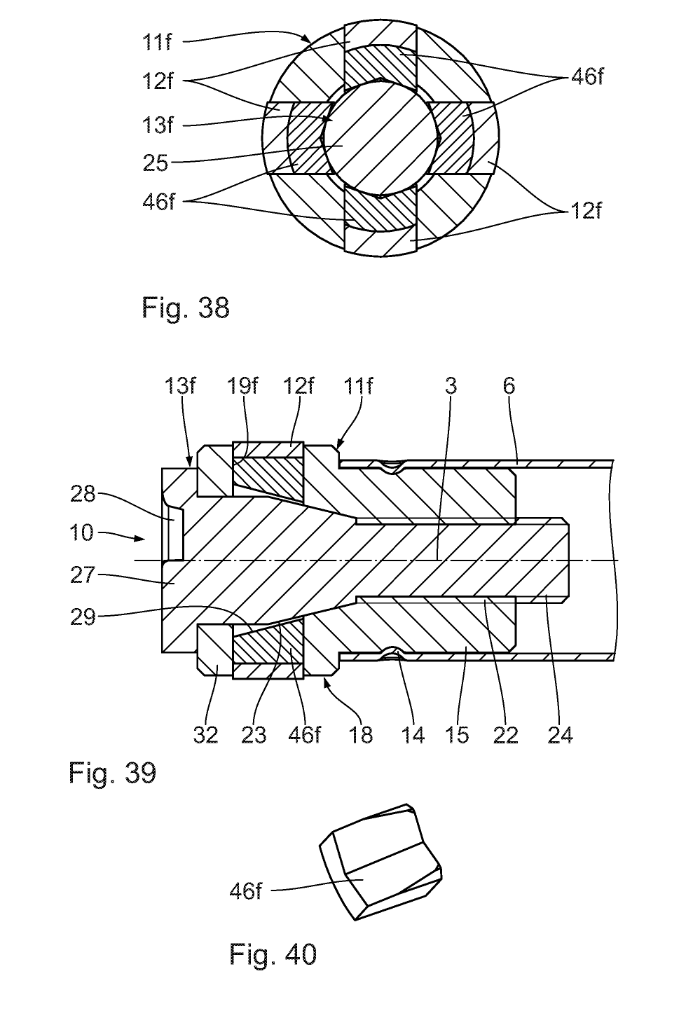

A seventh exemplary embodiment of the invention is described below with reference to FIGS. 36 to 40. Structurally identical parts are given the same reference signs as in the previous exemplary embodiments, to the description of which reference is hereby made. Structurally different, but functionally identical parts are given the same reference signs followed by an f.

The substantial difference over the previous exemplary embodiments consists in that the displacement elements 46f are arranged in a window-like radial recess 19f of the friction lining carrier 1 if and are arranged so as to be shiftable in a manner guided in the radial direction with respect to the longitudinal axis 3. By actuation of the adjustment element 13f, the displacement elements 46f are shifted radially along the radial recess 19f. The displacement elements 46f and the friction linings 12f which are arranged thereon and in particular are fastened thereto are fixed on the friction lining carrier 11f both in the circumferential direction about the longitudinal axis 3 and in the axial direction of the longitudinal axis 3. According to the exemplary embodiment shown, the friction lining carrier 11f has four radial recesses 19f. It goes without saying that more or fewer than four radial recesses can also be provided.

What is claimed is:

1. A frictional device for a frictional damper, wherein the frictional device comprises
a. a friction lining carrier,
b. at least one friction lining adjustably arranged on the friction lining carrier,
c. an adjustment element for adjustably arranging the at least one friction lining on the friction lining carrier.

2. A frictional device according to claim 1, wherein the friction lining carrier has a slotted adjustment guide by means of which the adjustment element, is arranged adjustably to the friction lining carrier.

3. A frictional device according to claim 2, wherein the friction lining carrier has a slotted adjustment guide by means of which the adjustment element, is arranged relative to the friction lining carrier.

4. A frictional device according to claim 2, wherein the friction lining carrier has a slotted adjustment guide by means of which the adjustment element, is arranged adjustably along an adjustment direction.

5. A frictional device according to claim 1, wherein the adjustment element has a pressing portion for applying a pressing force to the at least one adjustable friction lining

6. A frictional device according to claim 5, wherein the pressing portion has a contour which is variable at least in sections along an adjustment direction.

7. A frictional device according to claim 5, wherein the pressing portion interacts with the at least one adjustable friction lining in such a manner that a pressing force acting on the friction lining by adjustment of the adjustment element along the adjustment direction is oriented transversely with respect to the adjustment direction.

8. A frictional device according to claim 7, wherein the pressing portion interacts with the at least one adjustable friction lining in such a manner that a pressing force acting on the friction lining by adjustment of the adjustment element along the adjustment direction is oriented radially with respect to the adjustment direction.

9. A frictional device according to claim 1, wherein the adjustment element has an actuating portion which is designed noncircularly in a plane oriented perpendicularly to the adjustment direction.

10. A frictional device according to claim 1, comprising an actuating element for actuating the adjustment element.

11. A frictional device according claim 1, wherein the at least one adjustable friction lining is arranged annularly around the adjustment element.

12. A frictional device according to claim 1, wherein the at least one adjustable friction lining is held on the friction lining carrier in a manner secure against rotation.

13. A frictional device according to claim 1, wherein the friction lining carrier has a radial recess for the at least one adjustable friction lining

14. A frictional device according to claim 13, wherein the friction lining carrier has an window-like radial recess for the at least one adjustable friction lining

15. A frictional device according to claim 1, comprising at least one non-adjustable friction lining arranged on the friction lining carrier.

16. A frictional damper with a frictional device as claimed in claim 1.

17. A frictional damper according to claim 16, comprising a first housing part with a first fastening element and a second housing part with a second fastening element, wherein the housing parts are shiftable relative to each other along a longitudinal axis.

18. A frictional damper according to claim 17, wherein the first housing part is designed as an outer tube and the second housing part is designed as an inner tube which is insertable into the outer tube.

19. A frictional damper according to claim 16, wherein the at least one friction lining lies in a manner pressable adjustably against an inner side of the first housing part or against an inner side of the second housing part in order to produce a frictional force.

20. A frictional damper according to claim 16, wherein the frictional device is arranged in the frictional damper in such a manner that the adjustment direction is oriented concentrically with respect to the longitudinal axis.
